(19) United States
(12) Patent Application Publication
(10) Pub. No.: US 2026/0171074 A1
(43) Pub. Date: Jun. 18, 2026

(54) MULTI-MODEL GESTURE TO AUDIO TRANSLATION

(71) Applicant: Optum, Inc., Minnetonka, MN (US)

(72) Inventor: Santosh MANDAL, Jharkhand (IN)

(21) Appl. No.: 18/981,176

(22) Filed: Dec. 13, 2024

(51) Int. Cl. G10L 13/08; G06F 3/01; G06V 10/40; G06V 40/10; G06V 40/16; G06V 40/18

(52) U.S. Cl. CPC G10L 13/08; G06F 3/011; G06V 10/40; G06V 40/107; G06V 40/175; G06V 40/18

(57) ABSTRACT

Various embodiments of the present disclosure provide a gesture translation pipeline that improves the functionality of a computer in various aspects. The techniques comprise receiving an image that depicts a facial expression and a hand position of a user, generating, using a parallel feature extraction model of a multi-stage machine learning architecture, a set of facial features and a set of hand features from the image, generating, using an aggregation model of the multi-stage machine learning architecture, a text prediction corresponding to the image based on the set of facial features, the set of hand features, and a set of defined terms associated with the multi-stage machine learning architecture, and initiating a prediction-based action based on the text prediction.

### BACKGROUND

Various embodiments of the present disclosure address technical challenges related to gesture recognition and translation using computer vision and machine learning technologies. Historically, computer systems have struggled to accurately interpret and translate complex human gestures into meaningful digital outputs. For example, traditional gesture recognition techniques rely on simplistic rule-based algorithms or limited datasets, resulting in poor accuracy and limited versatility across different users and environments. Moreover, traditional gesture recognition techniques require specific, pre-defined gestures requiring steep learning curves that reduce user adoption. Additionally, such systems traditionally focus solely on hand movements, and neglect other non-verbal cues, such as facial expressions and eye movements, that provide contextual data for improving the accuracy and subjectivity of gesture predictions.

### BRIEF DESCRIPTION OF THE DRAWINGS

FIG. 1 depicts a block diagram of an example architecture in accordance with some embodiments of the present disclosure.

FIG. 2 depicts a block diagram an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of an example multi-stage gesture translation pipeline in accordance with some embodiments of the present disclosure.

FIG. 5 depicts a flowchart of an example model training process in accordance with some embodiments of the present disclosure.

FIG. 6 depicts a flowchart of an example gesture recognition process in accordance with some embodiments of the present disclosure.

FIG. 7 depicts a flowchart of an example retraining process in accordance with some embodiments of the present disclosure.

### DETAILED DESCRIPTION

Various embodiments of the present disclosure provide machine learning architectures and pipelines that improve the functionality of a computer with respect to gesture recognition. To do so, some embodiments of the present disclosure provide a multi-stage machine learning architecture that defines complementary machine learning stages to generate improved predictions with less computing resources. To overcome performance deficiencies with traditional gesture recognition models, the multi-stage architecture adapts a set of feature extraction techniques in a first, feature extraction, stage to preemptively extract multiple features from an input image. By doing so, the multi-stage architecture may feed a set of predictive features from an image to a second, aggregation, layer of the multi-stage architecture that may be trained to synthesize textual and audio outputs for an image from combinations of intermediate predictive features. This, in turn, allows the multi-stage architecture to learn gesture predictions from multiple, disparate portions of an image. By doing so, the multi-stage architecture may be trained to generate comprehensive predictions with increased accuracy, increased granularity of outputs, and contextual metadata that is missing from traditional gesture recognition techniques that rely on a single portion of an image (e.g., hand positioning). Ultimately, the techniques of the present disclosure enable improved predictions that, unlike traditional techniques, may handle complex gesture and facial expression combinations without reductions in predictive accuracy.

More particularly, traditional gesture recognition techniques are limited to analyzing hand positions alone and lack the ability to incorporate facial expressions and other contextual cues that are predictive of the intent behind the hand positions. This leads to inaccuracies in communication between users and computer systems. The multi-stage process of the present disclosure automates and enhances the gesture recognition process by leveraging parallel feature extraction models that extract features from both hand positions and facial expressions depicted in an image and an aggregation model configured to synthesize these features into a comprehensive prediction. By doing so, the multi-stage process enables the creation and maintenance of a universal translation service between visual inputs (gestures and facial expressions) and textual outputs. This ensures that the interpretation of gestures is more nuanced and contextually aware. Moreover, by executing the feature extraction models in parallel, the multi-stage process of the present disclosure enables contextually aware prediction in real time. This, in turn, allows for near real time gesture translation that accounts for both gesture and facial expressions cues to enhanced communication between users of the computing device(s) so configured.

Examples of technologically advantageous embodiments of the present disclosure comprise methods for processing digital images to improve the downstream prediction therefrom. By doing so, some embodiments of the present disclosure improve downstream digital image rendering operations including the translation of rendered images to audio signals. In this way, the gesture recognition techniques of the present disclosure improves user interfaces by enabling more complex translations of image data from video interfaces to audio signals suitable for audio interfaces. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

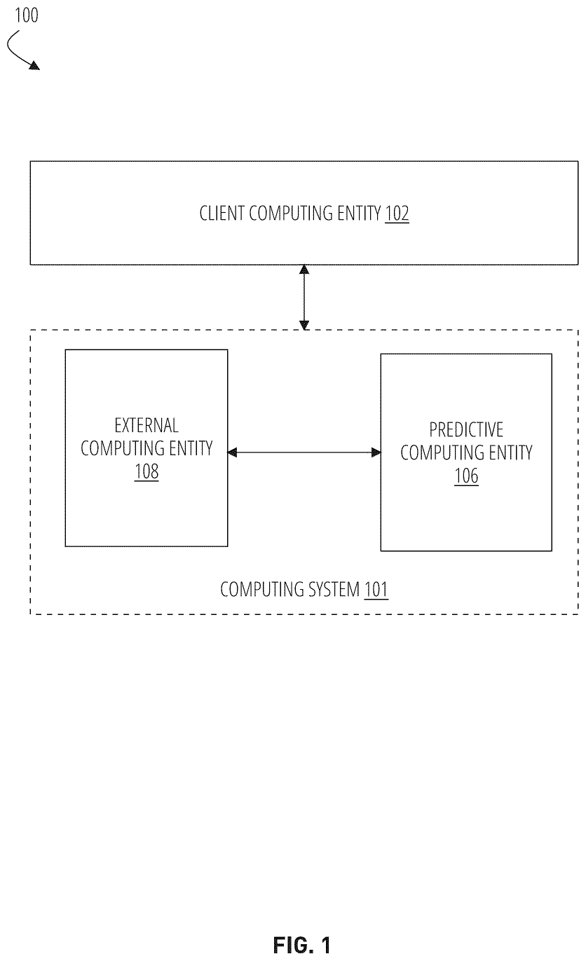

FIG. 1 depicts an example overview of an architecture 100 in accordance with some embodiments of the present disclosure. The architecture 100 comprises a computing system 101 configured to receive an image from client computing entities 102, process the image, and provide an output, such as an audio signal, to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to a gesture recognition task. Some techniques of the present disclosure may adapt traditional models to a cohesive framework, such as the multi-stage machine learning architecture, for more efficiently translating gestures to audio outputs.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., gesture translation) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as a training dataset, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

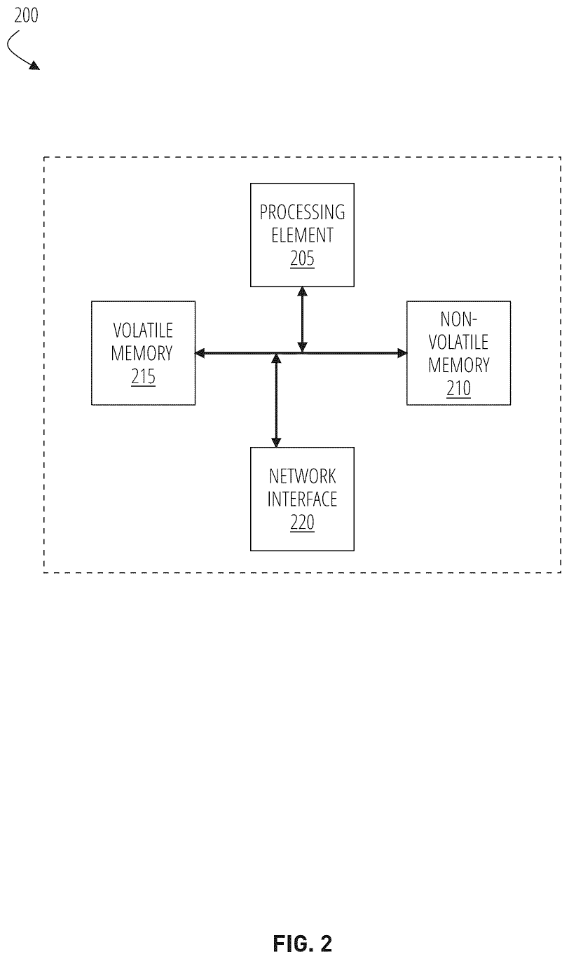

FIG. 2 depicts an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1 xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

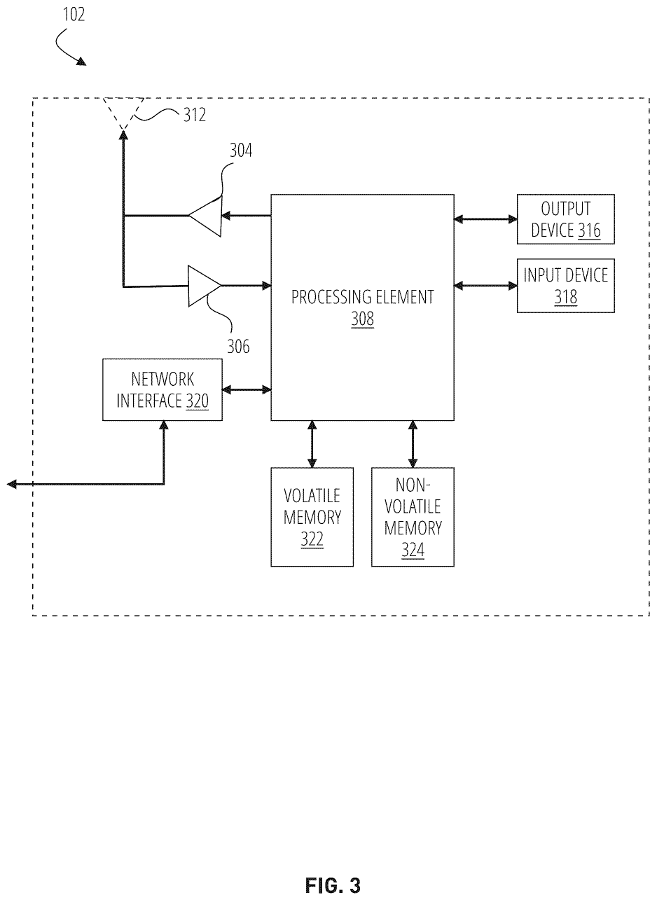

FIG. 3 depicts an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to gesture translation technology. In particular, systems and methods are disclosed herein that implement machine learning and image manipulation techniques to improve image interpretation. By doing so, the machine learning and image manipulation techniques of the present disclosure enable gesture translation processes that, when executed on a computer, improve translation of a images to audio outputs. This, in turn, may improve the functionality of a computer with respect to various computing tasks, including gesture translation, and/or the like.

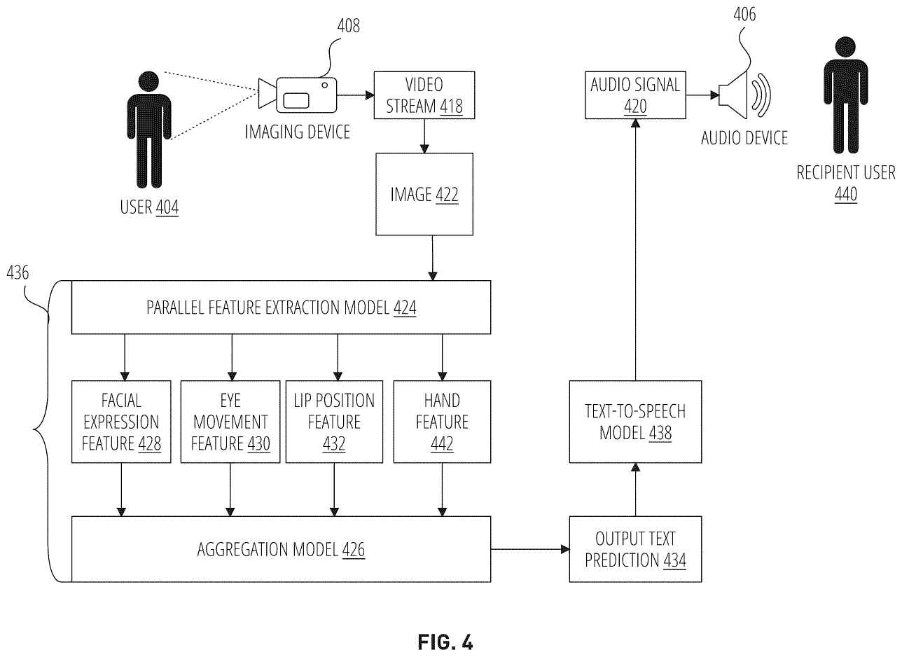

FIG. 4 depicts an operational diagram 400 of an example multi-stage gesture translation pipeline in accordance with some embodiments of the present disclosure. The multi-stage gesture translation pipeline comprises one or more of a first, feature extraction stage, a second, gesture prediction stage, and a third, speech conversion stage that collectively enable the accurate and comprehensive translation of a video stream 418 to audio signals 420 in near real time. Unlike traditional gesture translation techniques, the multi-stage gesture translation pipeline implements a parallel feature extraction model 424, during a feature extraction stage, to extract an expansive set of predictive features from both a facial expression and hand position within an image 422. By supplementing the second, gesture prediction stage, with these features, the multi-stage gesture translation pipeline enables more comprehensive gesture predictions that may be learned from a combination of communication cues ignored by other gesture recognition techniques. This, in turn, improves the accuracy of gesture predictions, while also capturing contextual details, such as sentiment predictions, that may modify an intended meaning and/or an intended communication style for conveying the meaning to a recipient user 440. In this way, the multi-stage gesture translation pipeline may enable speech conversions, during the third, speech conversion, stage that combine textual insights and sentiment insights to produce audio signals 420 that more accurately convey the intent behind a user's 404 gestures. Thus, the sequence of stages of the multi-stage machine learning architecture 436 improve gesture translation technology by enabling more accurate and comprehensive gesture predictions and, by implementing parallel processing streams during the first, feature extraction stage, these benefits may be achieved without increasing timing constraints.

In some embodiments, during a first stage of the multi-stage gesture translation pipeline, the computing system 101 (and/or a portion thereof) receives an image 422 that depicts a facial expression and a hand position of a user 404. The image 422 may be one standalone image 422 or one of a set of images in a video stream 418. The video stream 418, for example, may be recorded through a user interface that comprises one or more imaging devices 408 of the user device. In some examples, the image 422 may be received and processed by one or more user devices (e.g., client computing entity 102) of the computing system 101. In addition, or alternatively, the image 422 may be received from a user device and processed by one or more computing entities (e.g., predictive computing entity 106, external computing entity 108).

In some embodiments, the video stream 418 comprises a sequence of video frames depicting a user 404 providing one or more hand gestures. The video stream 418 may be captured by an imaging device 408, such as a camera integrated into a user device (e.g., a smartphone, eyewear, surveillance camera). The video stream 418 may be input directly (and/or after one or more preprocessing operations) to the multi-stage gesture translation pipeline to provide a continuous flow of visual information (e.g., images 422) that may be analyzed to interpret gestures of a user 404. In some example, the video stream 418 may be processed using computer vision techniques (e.g., OpenCV) to extract individual images 422 (e.g., video frames) for analysis by the multi-stage gesture translation pipeline. For instance, a video frame from the video stream 418 may be treated as a discrete image that may be further processed by various components of the multi-stage gesture translation pipeline. The video stream 418 may be processed in near real-time, allowing for immediate interpretation of the user 404 gestures and expressions. In addition, or alternatively, the video stream 418 may be stored (e.g., with verification feedback) as part of a training dataset to track changes in gestures and expressions over time and continuously improve the accuracy of gesture recognition, as described herein.

In some embodiments, the video stream 418 comprises a sequence of video frames with a field of view that captures a facial expression and a hand position of a user 404. A user 404, for example, may comprise a person depicted within a video frame that is providing one or more gestures for translation by the multi-stage gesture translation pipeline of the present disclosure. For example, the user 404 may be the primary subject of the video stream 418 and a source of the visual information that the multi-stage gesture translation pipeline processes to generate a text prediction 434 reflective of gesture performed by the user 404 and recorded by the video stream 418. In some example, the user 404 may interact with a user interface (e.g., imaging device 408) to capture a gesture and contextual facial expressions. In some examples, the user 404 may comprise an individual with a speech impairment and/or communication difficulties. In such a case, the user 404 may interact with the user interface (e.g., imaging device 408) to translate non-verbal gestures into audio signals 420 (e.g., spoken words) interpretable to a recipient user 440. For example, a user 404 may interact the user interface in various settings, such as healthcare facilities for patient communication, telemedicine consultations, and/or in everyday situations to facilitate communication with other, recipient users 440. As described herein, by capturing both the facial expression and the hand position of a user 404, a video stream 418 may improve the generalizability and adaptability of the multi-stage gesture translation pipeline to interpret a wide range of gestures, supplemented by expressions, to provide users 404 with a more natural and intuitive means of communication, enhancing their ability to express themselves in various social and professional contexts.

In some embodiments, the image 422 refers to a single video frame from a video stream 418. An image 422 may depict a snapshot of a gesture performed by a user 404 within a field of view of an imaging device 408. In some examples, the field of view of the imaging device 408 may comprise a facial expression and hand position of the user 404. For example, the image 422 may depict a facial expression and hand position of the user 404 at a specific point in time. An image 422 of the video stream 418 may be processed individually and/or in combination with one or more previous images by one or more machine learning models of the present disclosure to extract visual features predictive of an intent of the user 404.

In some examples, the image 422 may be represented as a digital matrix of pixel values, which can be manipulated and analyzed using various image processing techniques. These techniques may include color space conversions, noise reduction, edge detection, and other preprocessing steps to enhance the quality and relevance of the visual features within the image 422. In some examples, the image 422 may be preprocessed to extract one or more image representations from the image 422 for a parallel feature extraction process. For instance, the image 422 may be divided into one or more image representations that focus on one or more a specific areas of interest, such as a hand position/configuration and/or facial features of the user 404. By doing so, portions of an image 422 may be processed in parallel to generate a set of predictive features based on different portions of the image 422. In some examples, an image 422 may be associated with one or more previous and/or subsequent video frames of the video stream 418. The temporal relationship between such images in the video stream 418 may be leveraged to track changes in gestures and expressions over time to track the performance of different gestures throughout the video stream 418.

In some embodiments, a facial expression describes one or more movements or configurations of the facial muscles of a user 404 that convey emotional states, non-verbal communications, and/or the like. A facial expression, for example, may provide additional context and/or nuance to a hand position of a user 404 to enhance the overall accuracy of the multi-stage gesture translation pipeline. Facial expressions may be detected and analyzed using computer vision techniques and/or machine learning models specifically trained for facial feature recognition. As described herein, these models may employ convolutional neural networks (CNNs) and/or other deep learning architectures to identify facial landmarks and track their movements over time. For example, a facial expression may be detected and/or interpreted to extract a set of facial features using one or more machine learning models of a parallel feature extraction model 424. The set of facial features may comprise observations and/or predictions extracted by identifying the presence and/or location of faces within the image 422, locating specific facial areas of interest, such as eyes, eyebrows, nose, mouth, and/or the like, and then processing, using one or more machine learning models of a parallel feature extraction model 424, the specific facial areas of interest. The facial areas of interest, for example, may comprise bounding boxes defined by image coordinates, semantic segmentations, and/or the like. In some examples, the set of facial features may be combined with other features, such as hand positions, to generate more accurate and context-aware text predictions that capture not just the literal meaning of gestures but also the emotional intent behind them.

In some embodiments, a hand position describes one or more key landmarks from a hand placement of a user 404 within an image 422. A hand position, for example, may describe a position of one or more fingertips, a palm center, and/or other relevant features. A hand position may form a basis for interpreting an intended gesture performed by a user 404. A hand position may be detected and tracked using computer vision techniques and/or machine learning models specifically trained for gesture recognition. These models may employ frameworks, such as MediaPipe, which provides hand landmark detection capabilities by identifying a presence and/or location of one or more hands within the image 422, locating one or more specific points on the hand, such as fingertips, knuckles, the center of the palm, and/or the like, and determining the three-dimensional orientation and/or configuration of the hand based on the one or more specific points.

In some embodiments, the computing system 101 generates, using a parallel feature extraction model 424 of a multi-stage machine learning architecture 436, a set of facial features and a set of hand features from the image 422 based on the facial expression and/or hand position of the user as depicted by the image 422. In some examples, the set of facial features and/or the set of hand features 442 may be based on a previous image that temporally precedes (e.g., one or more images that come before the image in time) the image 422 within a set of images of video stream 418. For instance, the set of hand features 442 may comprise observations and/or predictions extracted by identifying the presence, location, and/or movement of hands within the image 422. In some examples, the set of hand features 442 comprise a gesture recognition classification based on a hand or finger position change from the previous image to the image 422 As further examples, the set of facial features may comprise one or more of (a) a facial expression feature 428 that identifies a sentiment classification (e.g., a sad, happy, or other defined emotion) for the user 404, (b) an eye movement feature 430 that identifies a focus classification (e.g., a focus direction, a level of focus based on a number of directionality changes) for the user 404, and/or (c) lip position feature 432 that identifies a lip movement classification based on a lip position change from the previous image to the image 422. In some examples, the sentiment classification may be based on a change of the facial expression from a previous facial expression of the previous image to the image 422. In addition, or alternatively, the eye movement feature 430 may be based on a change in eye focus from the previous facial expression to the facial expression of the image 422.

In some embodiments, the multi-stage machine learning architecture 436 is an end-to-end model pipeline that includes a parallel feature extraction model 424 and a connected aggregation model 426. This architecture is designed to process complex input data, such as images 422 containing hand gestures and facial expressions and generate text predictions 434 that synthesize features across the hand gestures and facial expressions. The multi-stage machine learning architecture 436 may define one or more processing constraints and/or one or more transfer channels between the parallel feature extraction model 424 and the aggregation model 426. For example, the multi-stage machine learning architecture 436 may include an input layer configured to route an image 422 (and/or one or more image representations thereof) to one or more of a set of feature extraction models of the parallel feature extraction model 424. In some examples, this may facilitate parallel processing of the image 422 by one or more of the set of feature extraction models within the parallel feature extraction model 424. In addition, or alternatively, the multi-stage machine learning architecture 436 may include a transfer layer configured to route intermediate outputs (e.g., facial features, hand features, etc.) from the parallel feature extraction model 424 to the aggregation model 426. The aggregation model 426 may be trained to synthesize the intermediate outputs to generate a text prediction 434 that may be output from the multi-stage machine learning architecture 436 responsive to an image 422. In this manner, the multi-stage machine learning architecture 436 may extract and combine multi-modal features, generated in parallel, to create a text prediction 434 that outperforms (e.g., in terms of speed, accuracy, and comprehensiveness) traditional gesture recognition techniques.

In some embodiments, the parallel feature extraction model 424 of the multi-stage machine learning architecture 436 comprises a set of feature extraction models. The set of feature extraction models may enable parallel processing of an image 422 by duplicating and/or dividing the image 422 into a set of image representations that may be simultaneously processed by one or more of the set of feature extraction models.

In some embodiments, the parallel feature extraction model 424 comprises a set of feature extraction models that are respectively trained to extract a set of intermediate features from an image 422. In some examples, the set of feature extraction models may process one or more different image representations from the image 422, in parallel, to generate a set of feature descriptions and/or intermediate predictions. For example, the parallel feature extraction model 424 may comprise one or more gesture recognition models configured to extract hand features 442 from the image 422, one or more expression recognition models configured to extract one or more facial expression features 428, one or more eye tracking models configured to extract one or more eye movement features 430, one or more lip tracking models configured to extract one or more lip position features 432, and/or the like. In some examples, one or more of the feature extraction models may include one or more different network architectures, such as convolutional neural networks (CNNs), recurrent neural networks (RNNs), and/or the like that are specifically trained for a particular feature extraction task.

In some embodiments, an image representation is a portion of an image 422 that is relevant to a particular feature extraction model of the parallel feature extraction model 424. An image representation, for example, may be defined by a bounding box that captures a specific area of interest within an image 422, such as the user's hands, face, and/or portions thereof. In some examples, one or more image representations may be generated using computer vision techniques, such as object detection and segmentation models (e.g., CNNs, RNN, or other machine learning technique) trained to identify and localize specific features within an image 422. For example, the computer vision techniques may include (i) a hand detection model configured to generate a bounding box around a hand position within an image, a hand classification associated with the bounding box, an instance segmentation and/or semantic segmentation of the bounding box, an embedding generated by an encoder for the bounding box, and/or the like, (ii) a face detection model configured to generate a bounding box around a facial expression within an image 422, a facial expression classification associated with the bounding box, an instance segmentation and/or semantic segmentation of the bounding box, an embedding generated by an encoder for the bounding box, and/or the like, among other examples. Once generated, one or more image representations may be routed to one or more feature extraction models of the parallel feature extraction model 424 within the multi-stage machine learning architecture 436. In this way, an image representation may tailor an image 422 to each of a set of different feature extraction models of the parallel feature extraction model 424 to improve the prediction accuracy of each model, while facilitating parallel processing streams.

In some embodiments, the set of feature extraction models comprise one or more gesture recognition models and/or one or more facial recognition models. For example, the one or more gesture recognition models and/or one or more facial recognition models may comprise one or more of a first, second, third, and/or fourth feature extraction model that may be configured to process the image 422 and/or the same or different image representations extracted from the image 422. For example, the computing system 101 (e.g., via a first parallel processing stream) may generate, using a first feature extraction model of the set of feature extraction models, a facial expression feature 428 based on a first image representation of the set of image representations. In some examples, the computing system 101 (e.g., via a second parallel processing stream) may generate, using a second feature extraction model of the set of feature extraction models, an eye movement feature 430 based on a second image representation of the set of image representations. In addition, or alternatively, the computing system 101 (e.g., via a third parallel processing stream) may generate, using a third feature extraction model of the set of feature extraction models, a lip position feature 432 based on a third image representation of the set of image representations. In some examples, the computing system 101 (e.g., via a fourth parallel processing stream) may generate, using a fourth feature extraction model of the set of feature extraction models, a hand feature 442 based on a fourth image representation of the set of image representations. In this manner, one or more of the facial expression feature 428, the eye movement feature 430, the lip position feature 432, and/or hand features 442 may be generated in parallel via parallel processing streams of the computing system 101.

In some embodiments, the first feature extraction model is an expression recognition model. The expression recognition model may include a machine learning facial expression detection model designed to analyze and classify facial expressions within an image 422 and/or across a sequence of images 422 within a video stream 418. The expression recognition model may comprise any machine learning architecture, such as a neural network (e.g., CNNs, RNNs, long short-term memory (LSTM) networks), generative models (e.g., Active Appearance Models (AAM)), statistical model (e.g., Constrained Local Models (CLM)), and/or the like. The expression recognition model may be configured to detect one or more facial landmarks of a facial expression and generate a facial expression feature 428 based on the one or more facial landmarks. In some examples, the expression recognition model may be trained using a training dataset of labeled facial expressions, covering a wide range of emotions and/or subtle variations thereof. For example, a range of detected emotions may be configured by a range of emotions reflected within the training dataset. For instance, the training dataset may be designed to recognize both basic emotions (e.g., happiness, sadness, anger) and/or more complex and/or nuanced expressions thereof. In this manner, the expression recognition model may be trained to output a facial expression feature that provides emotional context to the user's gestures and enables more nuanced and accurate text predictions.

In some embodiments, a facial expression feature 428 is a sentiment classification derived from the muscle configuration of a facial expression. The facial expression feature 428, for example, may be generated, using the expression recognition model, by extracting facial muscle data (e.g., facial landmarks) and mapping the facial muscle data to one or more predefined sentiment categories, such as happiness, sadness, anger, surprise, fear, disgust, pain levels, and/or the like. In some examples, the facial expression feature 428 may include one or more domain specific classifications, such as pain levels, treatment responses, and/or like for a healthcare domain that may be used to assess a user's pain levels and/or emotional response to treatment, even when they are unable to verbalize their feelings.

In some embodiments, the second feature extraction model is an eye tracking model. The eye tracking model may include a machine learning eye detection and tracking model configured to track eye movement, eye focus patterns, and/or the like between one or more images of the video stream 418. The eye tracking model, for example, may include cascade classifier, and/or other computer vision model configured to locate eye regions within an image 422 (and/or image representation thereof) and extract key features, such as an iris, pupil, eye corners, and/or the like within the eye region. In some examples, the eye tracking model may implement one or more Kalman filtering, optical flow, and/or other techniques track eye movement between one or more images 422 of the video stream 418. In addition, or alternatively, the eye tracking model may include one or more machine learning frameworks (e.g., neural networks, random forests, support vector machines) configured to extract eye movement features 430, such as gaze direction, fixation points, and/or saccade patterns from the eye regions of the image 422 (and/or image representation thereof). In some examples, the eye tracking model may be trained on a datasets of labeled eye movement data to generate one or more defined eye movement features 430.

In some embodiments, an eye movement feature 430 is a classification that describes a user's attention within an image 422 and/or across one or more images 422 of a video stream 418. In some examples, the eye movement feature 430 may describe a position of the eyes and/or pupils over time to identify one or more eye movement patterns. The eye movement patterns, for example, may comprise fixations (when the eyes are relatively still, focusing on a specific point), saccades (rapid movements between fixations), smooth pursuits (when the eyes follow a moving object), and/or the like. In some examples, the eye movement feature 430 may include one or more defined attention categories, such as “focused attention,” “scanning,” “reading,” “distracted,” and/or the like.

In some embodiments, the third feature extraction model is a lip tracking model. The lip tracking model may include a machine learning lip monitoring model that detects and tracks lip movements within and/or between one or more images 422 of a video stream 418. The lip tracking model, for example, may include cascade classifier, and/or other computer vision model configured to locate mouth regions within an image 422 (and/or image representation thereof) and extract key features, such as a lip contours, and/or the like within the mouth region. In some examples, the lip tracking model may implement one or more Kalman filtering, optical flow, and/or other techniques track lip movement between one or more images 422 of the video stream 418. In addition, or alternatively, the lip tracking model may include one or more machine learning frameworks (e.g., neural networks, random forests, support vector machines) configured to extract lip position feature 432 from the mouth regions of the image 422 (and/or image representation thereof). In some examples, the lip tracking model may be trained on a dataset of labeled lip movement data to generate one or more defined lip position features 432.

In some embodiments, a lip position feature 432 is a lip movement classification, such as speech-related gestures, expressions of emphasis, and/or the like. For example, the lip position feature 432 may identify a lip movement pattern that describes lip spreading, pursing, rounding, or specific shapes associated with phonemes (e.g., the smallest units of sound in speech). In some examples, the lip position feature 432 may comprise a sequence of lip movement patterns that, when combined, form specific phonemes, words, or expressions of emphasis.

In some embodiments, the fourth feature extraction model is a gesture recognition model that processes at least a hand position portion of the image 422 to generate a hand feature 442 that describes a hand gesture within the image 422. The gesture recognition model may comprise any machine learning architecture, such as a CNN for spatial feature extraction from hand images, RNN, long short-term memory (LSTM) networks, and/or the like. The gesture recognition model may be configured to identify key spatial and/or temporal features of the hand gesture depicted within an image 422 (and/or image representation thereof) and classify the image 422 by mapping the extracted features to one or more predefined gesture categories (e.g., textual predictions). The gesture recognition model may be trained, via supervised training (e.g., back propagation as optimized using gradient descent), on training dataset of labeled hand gestures (e.g., sign language datasets, custom gesture vocabularies). In some examples, the gesture recognition model may be designed to recognize a wide range of gestures, from simple pointing or waving motions to complex sign language expressions as reflected by the training dataset. In some example, the training dataset may be user specific to enable the gesture recognition model to learn gestures specific to a user. For instance, a user 404 may provide verification feedback with respect to an image 422 that enables the computing system 101 to update a training dataset with user specific gestures. By doing so, a gesture recognition model may be configurable, through online training techniques, to a user 404/

In some embodiments, the gesture recognition model is configured to output at least one hand feature 442 for an image 422. A hand feature 442 may include a gesture classification for the image 422 that describes a textual prediction based on a hand position within the image 422. In some examples, a hand feature 442 may include a categorical label and/or probability distribution for one or more predefined gesture classes, a confidence score for at least one of the categorical labels, temporal attributes (e.g., a duration or timing of the predefined gesture class), spatial attributes (e.g., key points and/or vectors describing the hand's configuration), and/or the like. As described herein, a hand feature 442 may be customized and/or expanded to accommodate different gesture vocabularies, sign language systems, and/or user-specific gestures through verification feedback from the user 404. This flexibility allows a gesture recognition model to be adapted for various use cases and/or user populations to improve the accessibility and effectiveness of the multi-stage gesture translation pipeline across different communication contexts.

In some embodiments, during a second stage of the multi-stage gesture translation pipeline, the computing system 101 (and/or a portion thereof) generates, using an aggregation model 426 of the multi-stage machine learning architecture 436, a text prediction 434 corresponding to the image 422. The text prediction 434 may be based on the set of facial features, the set of hand features, and/or a set of defined terms associated with the multi-stage machine learning architecture 436. The text prediction 434, for example, may comprise a textual prediction and/or a sentiment prediction translated from a gesture and/or facial expression depicted within the video stream 418.

In some embodiments, the aggregation model 426 is a machine learning model (and/or metamodel) that is configured (e.g., trained) to synthesize the outputs of the parallel feature extraction models 424 to generate a text prediction 434 for a user 404 based on one or more images 422 of the video stream 418. The aggregation model 426 may include a second, aggregation layer of the multi-stage machine learning architecture 436 that is trained to generate a prediction based on the intermediate predictions produced by the parallel feature extraction models 424 in a previous feature engineering layer of the multi-stage machine learning architecture 436. The aggregation model 426 may include one or more different machine learning architectures, such as deep neural networks, CNNs, RNNs, transformers, and/or the like. The aggregation model 426 may be trained to combine and correlate sets of intermediate outputs of different modalities (e.g., hand gestures, facial expressions, eye movements, and lip positions) as output from one or more of the set of feature extraction models of the parallel feature extraction model 424 to generate a text prediction 434 synthesized from the intermediate outputs.

By way of example, the aggregation model 426 may include a neural network architecture (e.g., deep neural networks, CNN, RNN, transformer) that is trained, using one or more machine learning training techniques (e.g., backpropagation of errors as optimized using gradient descent), to generate a text prediction 434 based on a labeled training dataset. The labeled training dataset may include a set of training entries. A training entry of the set of training entries may comprise one or more of a training text prediction, one or more training images, and/or one or more training features (e.g., a set of training hand features 442, a set of training facial features). For instance, the aggregation model 426 may be trained individually, without use of the parallel feature extraction model 424, using a set of predetermined and/or synthetic training features. In addition, or alternatively, the aggregation model 426 may be trained using the parallel feature extraction model 424 by determining the training features from a training image for each training iteration.

In some examples, the aggregation model 426 may be trained based on verification feedback that describes text predictions for a particular user case (e.g., a user, a speech impediment). For example, the aggregation model 426 may be initially trained using a training dataset with a plurality of domain-generic training entries. In addition, or alternatively, the aggregation model 426 may be retrained (e.g., finetuned) at a time interval (e.g., a set time interval, in response to a retraining stimulus, such as a threshold number of instances of new verification feedback) based on verification feedback. The verification feedback may comprise a new training entry that comprises one or more of a new training image, new training features, or a new training text prediction. In addition, or alternatively, the verification feedback may include a verification, modification, and/or rejection of a text prediction 434. In some examples, the verification, modification, and/or rejection of the text prediction 434 may include an annotation that describes an updated training text prediction for an image 422. In this manner, an aggregation model 426 may be trained and/or retrained over time to learn features, gestures, and/or the like that are specific to a particular environment, user 404, and/or the like.

In some examples, a training text prediction (and/or verification feedback) may comprise a textual prediction for training the aggregation model 426 to synthesize a set of intermediate feature outputs into a textual representation of a gesture (as modified by one or more facial expressions, eye movements, and/or lip positions). In addition, or alternatively, the training text prediction may comprise a sentiment prediction for training the aggregation model 426 to synthesize a set of intermediate feature outputs into a textual representation of a user sentiment (as modified by one or more facial expressions, eye movements, and/or lip positions). By doing so, the aggregation model 426 may be trained to output a comprehensive text prediction 434, based on the correlated inputs from the parallel feature extraction models 424, that captures a literal meaning of a user's gestures and an emotional context and/or nuanced intentions conveyed through a sentiment prediction accompanying the textual prediction.

In some embodiments, the text prediction 434 is a synthesized output of the aggregation model 426 that synthesizes one or more of hand and/or finger recognition with facial expression, eye, and/or lip detection into a comprehensive gesture prediction. The text prediction 434, for example, may include a textual prediction and/or a sentiment prediction for a user 404 based on one or more images 422 from the video stream 418. In some examples, the text prediction 434 may comprise an intermediate translation between a gesture provided by a user 404 and an audio signal 420 reflective of the gesture.

In some embodiments, a textual prediction is one a component of a text prediction 434. The textual prediction may comprise a mapping between a user's hand gestures (and facial expression) and corresponding spoken words and/or phrases. The textual prediction represents a computing system 101 interpretation of a user's non-verbal communication in a text format, serving as an intermediate output of a gesture-to-voice conversion process. The textual prediction, for example, may comprise one or more structured and/or natural language words, phrase, sentences, and/or the like.

In some embodiments, a sentiment prediction is a sentiment classification for a user 404 based on the user's facial expressions. The sentiment prediction may interpret an emotional state and/or attitude of the user 404 as contextual metadata for a textual prediction that provides an additional layer of context to a text prediction 434. The sentiment prediction, for example, may include a happy, sad, angry, and/or any other emotional tone that may contextualize text translated from a gesture.

In some embodiments, the computing system 101 initiates a prediction-based action based on the text prediction 434. For example, the computing system 101 may generate, using a text-to-speech model 438, an audio signal 420 based on the text prediction 434. For instance, the computing system 101 may select, using the text-to-speech model 438, an audio signal 420 from a set of defined audio signals based on the textual prediction and/or the sentiment prediction of the text prediction 434. In some examples, the set of defined audio signals comprises a defined audio signal that corresponds to a text-sentiment pair associated with a corresponding textual prediction and a corresponding sentiment prediction.

In some embodiments, during the third stage of the multi-stage gesture translation pipeline, the computing system 101 outputs, using a user interface, such as the audio device 406, the audio signal 420 to a recipient user 440. For example, the user device may include one or more audio devices 406 configured to output the audio signal 420. In addition, or alternatively, the video stream 418 may be recorded by a user device and the audio signal 420 may be output by one or more audio devices 406 of a remote device physically separate from the user device.

In some embodiments, the audio signal 420 is an audio translation of a gesture recorded by an imaging device 408 that is translated from a text prediction 434. An audio signal 420 may include an auditory output of the multi-stage gesture translation pipeline that translates the user's gestures and/or facial expressions into spoken words and/or sounds. The audio signal 420 may be generated using a text-to-speech model 438 configured to convert a text prediction 434 into a synthesized voice by retrieving a pre-recorded audio file corresponding to the recognized gesture and/or expression outputting the pre-recorded audio file by the audio device 406.

In some embodiments, the text-to-speech model 438 is a TTS algorithms that synthesize speech from a text prediction 434. The text prediction 434 may be designed to convert written text into natural-sounding spoken words, serving as the final step in the gesture-to-voice conversion process. The text-to-speech model 438 may include a deep learning approach, such as a sequence-to-sequence model, WaveNet, Tacotron, and/or the like. These text prediction 434 may be trained to map sequences of text to corresponding audio waveforms, capturing nuances of pronunciation, intonation, and rhythm. Some advanced TTS models also incorporate neural vocoders, which generate high-quality speech waveforms from intermediate acoustic representations. In some examples, the text-to-speech model 438 may be trained to map a text prediction 434 to one of a set of defined audio signals that corresponds to at least one of a textual prediction and/or sentiment prediction of the text prediction 434.

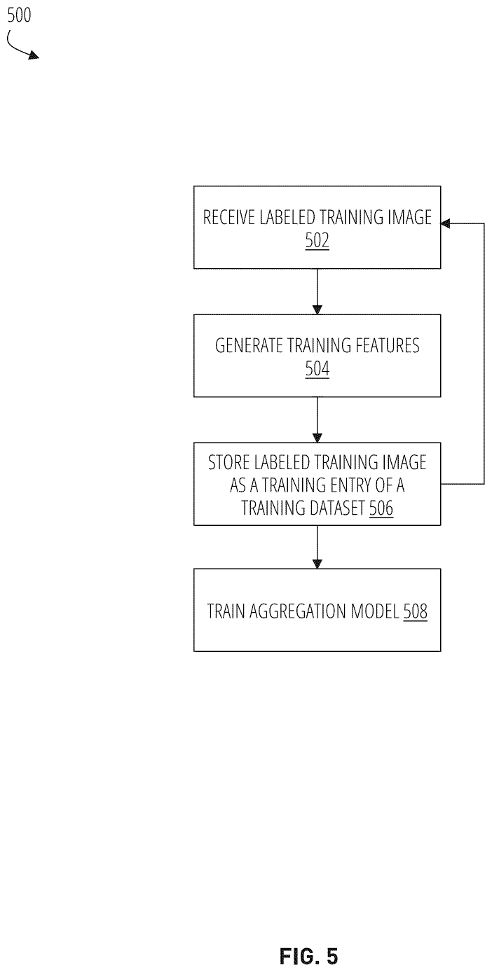

FIG. 5 is a flowchart diagram of an example model training process 500 in accordance with some embodiments of the present disclosure. The flowchart diagram depicts a training process for creating a multi-stage machine learning architecture configured to synthesize a set of hand and facial features into a single text prediction. The process 500 may be implemented by one or more computing devices, entities, and/or systems described herein. For example, via the various steps/operations of the process 500, the computing system 101 may generate a multi-modal training dataset and train an aggregation model of the multi-stage machine learning architecture to generate a text prediction from multiple, multi-modal features traditionally ignored by gesture recognition techniques. By doing so, the process 500 improves computer functionality by improving gesture recognition relative to traditional gesture recognition techniques.

FIG. 5 illustrates an example process 500 for explanatory purposes. Although the example process 500 depicts a particular sequence of steps/operations, the sequence may be altered without departing from the scope of the present disclosure. For example, some of the steps/operations depicted may be performed in parallel or in a different sequence that does not materially impact the function of the process 500. In other examples, different components of an example device or system that implements the process 500 may perform functions at substantially the same time or in a specific sequence.

In some embodiments, the process 500 comprises, at operation 502, receiving a labeled training image. For example, the computing system 101 may receive a labeled training image reflective of a user and/or one or more features thereof. For example, the labeled training image may comprise a facial expression and/or hand position of the user. In addition, or alternatively, the labeled training image may include a ground truth label that describes a training text prediction for the training image.

In some embodiments, the process 500 comprises, at operation 504, generating training features from the labeled training image. For example, the computing system 101 may generate, using a parallel feature extraction model of the multi-stage machine learning architecture, a set of facial features and/or a set of hand features from the training image.

In some embodiments, the process 500 comprises, at operation 506, storing the labeled training image as a training entry of a training dataset. For example, the computing system 101 may store the labeled training image as a training entry of the training dataset.

In some embodiments, the process 500 comprises, at operation 508, training the aggregation model of the multi-stage machine learning architecture using the training dataset. For example, the computing system 101 may train the aggregation model of the multi-stage machine learning architecture using the training dataset. By way of example, the aggregation model may comprise a supervised machine learning model. The aggregation model may be trained, via back-propagation of errors using gradient descent, to optimize an accuracy between the ground truth label and a training text prediction generated for the training image based on the set of facial features and/or the set of hand features.

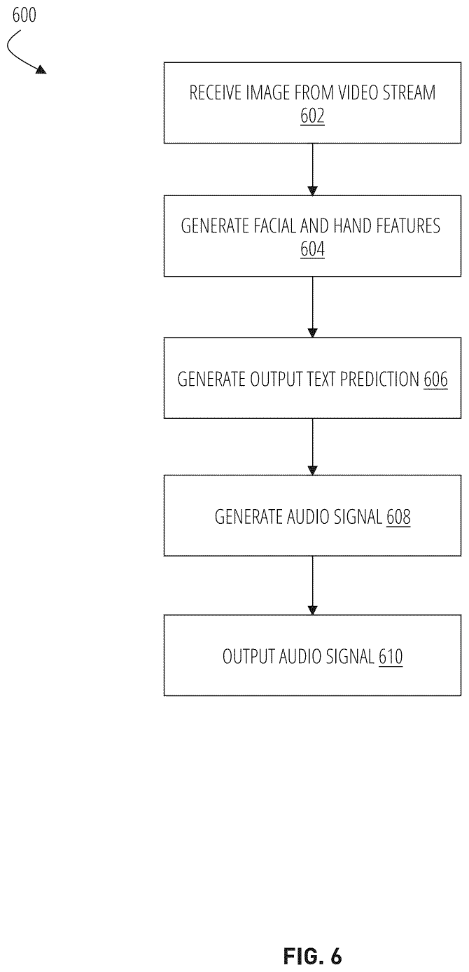

FIG. 6 is a flowchart diagram of an example gesture recognition process 600 in accordance with some embodiments of the present disclosure. The flowchart diagram depicts a gesture recognition technique for synthesizing a set of intermediate predictions into an output audio signal reflective of a gesture performed by a user. The process 600 may be implemented by one or more computing devices, entities, and/or systems described herein. For example, via the various steps/operations of the process 600, the computing system 101 may translate physical gestures, recorded by one or more images, into audio signals that capture both hand and facial expression of a user. By doing so, the process 600 improves computer functionality by improving gesture recognition relative to traditional gesture recognition techniques.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 comprises, at operation 602, receiving an image from a video stream. For example, the computing system 101 may receive an image that depicts a facial expression and a hand position of a user. In some examples, the image is one of a set of images in a video stream.

In some embodiments, the process 600 comprises, at operation 604, generating facial and hand features from the image. For example, the computing system 101 may generate, using a parallel feature extraction model of a multi-stage machine learning architecture, a set of facial features and a set of hand features from the image. In some examples, the set of facial features and the set of hand features may be based on a previous image that temporally precedes the image within the set of images. The set of facial features may comprise (a) a facial expression feature that identifies a sentiment classification for the user, (b) an eye movement feature that identifies a focus classification for the user, and/or (c) lip position feature that identifies a lip movement classification based on a lip position change from the previous image to the image. In addition, or alternatively, the set of hand features comprises a gesture recognition classification based on a hand or finger position change from the previous image to the image. In some examples, the sentiment classification may be based on a change of the facial expression from a previous facial expression of the previous image. In some examples, the eye movement feature is based on a change in eye focus from the previous facial expression to the facial expression.

In some examples, the parallel feature extraction model of the multi-stage machine learning architecture may comprise a set of feature extraction models. The computing system 101 may generate a set of image representations from the image. The computing system 101 may generate, using a first feature extraction model of the set of feature extraction models, a facial expression feature based on a first image representation of the set of image representations. The computing system 101 generate, using a second feature extraction model of the set of feature extraction models, an eye movement feature based on a second image representation of the set of image representations. In addition, or alternatively, the computing system 101 may generate, using a third feature extraction model of the set of feature extraction models, a lip position feature based on a third image representation of the set of image representations. In some examples, the computing system 101 may generate the facial expression feature, the eye movement feature, and the lip position feature in parallel.

In some embodiments, the process 600 comprises, at operation 606, generating a text prediction. For example, the computing system 101 may generate, using an aggregation model of the multi-stage machine learning architecture, a text prediction corresponding to the image based on the set of facial features, the set of hand features, and a set of defined terms associated with the multi-stage machine learning architecture. The text prediction may comprise a textual prediction and/or a sentiment prediction (e.g., as output by an expression recognition model).

In some embodiments, the process 600 comprises, at operation 608, generating an audio signal from the text prediction. For example, the computing system 101 may generate, using a text-to-speech model, an audio signal based on the text prediction. The text-to-speech model may select an audio signal from a set of defined audio signals based on the textual prediction and/or the sentiment prediction. In some examples, the set of defined audio signals may comprise a defined audio signal that corresponds to a text-sentiment pair associated with a corresponding textual prediction and a corresponding sentiment prediction.

In some embodiments, the process 600 comprises, at operation 610, outputting an audio signal based on the text prediction. For example, the computing system 101 may initiate a prediction-based action based on the text prediction. For instance, the prediction-based action may comprise outputting, using a user interface, the audio signal. The user interface may comprise one or more audio devices of a user device. In some examples, the image may be recorded by one or more imaging devices of the user device. In addition, or alternatively, the image may be recorded by one or more imaging devices of a user device.

Some techniques of the present disclosure enable the generation of action outputs that may be performed to initiate one or more real world actions to achieve real-world effects. The techniques of the present disclosure may be used, applied, and/or otherwise leveraged to generate text and audio outputs from physical gestures. In some examples, these outputs may trigger action outputs (e.g., through control instructions) to automate one or more actions. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

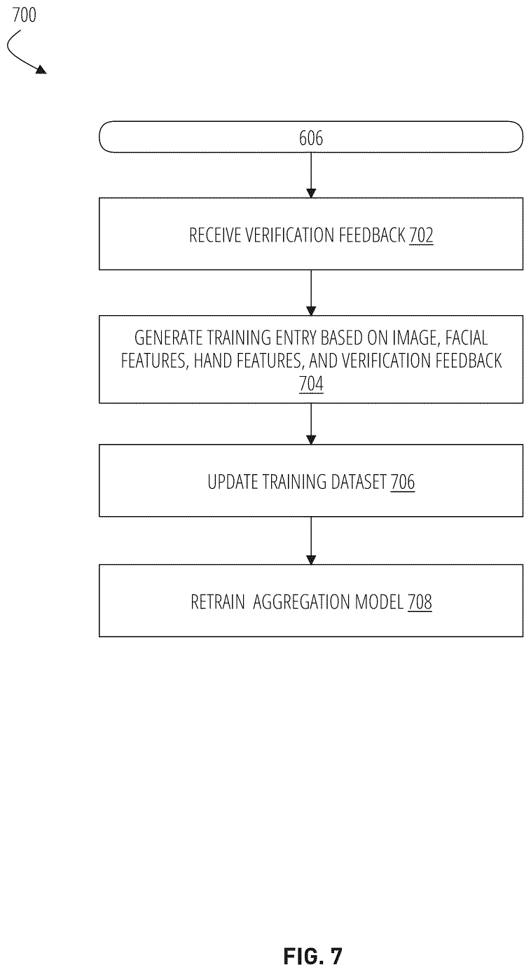

FIG. 7 is a flowchart diagram of an example retraining process 700 in accordance with some embodiments of the present disclosure. The flowchart diagram depicts a feedback based retraining process for a multi-stage machine learning architecture. The process 700 may be implemented by one or more computing devices, entities, and/or systems described herein. For example, via the various steps/operations of the process 700, the computing system 101 may continuously retrain a gesture recognition model to adapt to user and environments over time. By doing so, the process 700 improves computer functionality by improving gesture recognition relative to traditional gesture recognition techniques.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 may begin after operation 606, where the computing system 101 generates a text prediction for an image.

In some embodiments, the process 700 comprises, at operation 702, receiving verification feedback for the text prediction. For example, the computing system 101 may receive verification feedback from a user that annotates a text prediction with an intended textual prediction.

In some embodiments, the process 700 comprises, at operation 704, generating a training entry based on the image, facial features, hand features, and/or verification feedback. For example, the computing system 101 may generate a training entry based on the image, facial features, hand features, and/or verification feedback.

In some embodiments, the process 700 comprises, at operation 706, updating the training dataset with the training entry. For example, the computing system 101 may update the training dataset with the training entry.

In some embodiments, the process 700 comprises, at operation 708, retraining the aggregation model of the multi-stage machine learning architecture using the updated training dataset. For example, the computing system 101 may retrain the aggregation model of the multi-stage machine learning architecture using the updated training dataset. By way of example, the computing system 101 may initiate one or more supervised fine-tuning operations to retrain the aggregation model in response to a threshold number (e.g., 10, 100, 1000) of annotated training entries to convert a user agnostic model to a specific user.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising receiving, by one or more processors, an image that depicts a facial expression and a hand position of a user; generating, by the one or more processors and using a parallel feature extraction model of a multi-stage machine learning architecture, a set of facial features and a set of hand features from the image; generating, by the one or more processors and using an aggregation model of the multi-stage machine learning architecture, a text prediction corresponding to the image based on the set of facial features, the set of hand features, and a set of defined terms associated with the multi-stage machine learning architecture; and initiating, by the one or more processors, a prediction-based action based on the text prediction.

Example 2. The computer-implemented method of example 1, wherein the parallel feature extraction model of the multi-stage machine learning architecture comprises a set of feature extraction models and generating the set of facial features comprises determining a set of image portions from the image; generating, using a first feature extraction model of the set of feature extraction models, a facial expression feature based on a first image portion of the set of image portions; generating, using a second feature extraction model of the set of feature extraction models, an eye movement feature based on a second image portion of the set of image portions; and generating, using a third feature extraction model of the set of feature extraction models, a lip position feature based on a third image portion of the set of image portions.

Example 3. The computer-implemented method of example 2, wherein the facial expression feature, the eye movement feature, and the lip position feature are generated in parallel.

Example 4. The computer-implemented method of any of the preceding examples, wherein the image is one of a set of images in a video stream, the set of facial features and the set of hand features are based on a previous image associated with a previous time relative to the image, at least one of (i) the set of facial features comprises (a) a facial expression feature that identifies a sentiment classification for the user, (b) an eye movement feature that identifies a focus classification for the user, or (c) a lip position feature that identifies a lip movement classification based on a lip position change from the previous image to the image, or (ii) the set of hand features comprises a gesture recognition classification based on at least one of a hand or finger position change from the previous image to the image.

Example 5. The computer-implemented method of example 4, wherein at least one of the sentiment classification is based on a change of the facial expression from a previous facial expression of the previous image, or the eye movement feature is based on a change in eye focus from the previous facial expression to the facial expression.

Example 6. The computer-implemented method of any of the preceding examples, wherein initiating the prediction-based action based on the text prediction comprises generating, using a text-to-speech model, an audio signal based on the text prediction; and outputting, using a user interface, the audio signal.

Example 7. The computer-implemented method of example 6, wherein: the user interface comprises one or more audio devices of a user device and the image is recorded by one or more imaging devices of the user device, or the user interface comprises one or more audio devices of a second device and the image is recorded by the one or more imaging devices of the user device.

Example 8. The computer-implemented method of example 7, wherein the text prediction comprises text and a sentiment prediction and the text-to-speech model determines the audio signal from a set of defined audio signals based on the text and the sentiment prediction.

Example 9. The computer-implemented method of example 8, wherein the set of defined audio signals comprises a defined audio signal that corresponds to a text-sentiment pair associated with a corresponding textual prediction and a corresponding sentiment prediction.

Example 10. A system comprising one or more processors; and one or more memories storing processor-executable instructions that, when executed by the one or more processors, cause the one or more processors to perform operations comprising receiving an image that depicts a facial expression and a hand position of a user; generating, using a parallel feature extraction model of a multi-stage machine learning architecture, a set of facial features and a set of hand features from the image; generating, using an aggregation model of the multi-stage machine learning architecture, a text prediction corresponding to the image based on the set of facial features, the set of hand features, and a set of defined terms associated with the multi-stage machine learning architecture; and initiating a prediction-based action based on the text prediction.

Example 11. The system of example 10, wherein the parallel feature extraction model of the multi-stage machine learning architecture comprises a set of feature extraction models and generating the set of facial features comprises determining a set of image portions from the image; generating, using a first feature extraction model of the set of feature extraction models, a facial expression feature based on a first image portion of the set of image portions; generating, using a second feature extraction model of the set of feature extraction models, an eye movement feature based on a second image portion of the set of image portions; and generating, using a third feature extraction model of the set of feature extraction models, a lip position feature based on a third image portion of the set of image portions.

Example 12. The system of example 11, wherein the facial expression feature, the eye movement feature, and the lip position feature are generated in parallel.

Example 13. The system of any of examples 10 through 12, wherein the image is one of a set of images in a video stream, the set of facial features and the set of hand features are based on a previous image associated with a previous time relative to the image, at least one of (i) the set of facial features comprises (a) a facial expression feature that identifies a sentiment classification for the user, (b) an eye movement feature that identifies a focus classification for the user, or (c) a lip position feature that identifies a lip movement classification based on a lip position change from the previous image to the image, or (ii) the set of hand features comprises a gesture recognition classification based on at least one of a hand or finger position change from the previous image to the image.

Example 14. The system of example 13, wherein at least one of the sentiment classification is based on a change of the facial expression from a previous facial expression of the previous image, or the eye movement feature is based on a change in eye focus from the previous facial expression to the facial expression.

Example 15. The system of any of examples 10 through 14, wherein initiating the prediction-based action based on the text prediction comprises generating, using a text-to-speech model, an audio signal based on the text prediction; and outputting, using a user interface, the audio signal.

Example 16. The system of example 15, wherein the text prediction comprises text and a sentiment prediction and the text-to-speech model determines an audio signal from a set of defined audio signals based on the text and the sentiment prediction.

Example 17. One or more non-transitory computer-readable media storing processor-executable instructions that, when executed by one or more processors, cause the one or more processors to perform operations comprising receiving an image that depicts a facial expression and a hand position of a user; generating, using a parallel feature extraction model of a multi-stage machine learning architecture, a set of facial features and a set of hand features from the image; generating, using an aggregation model of the multi-stage machine learning architecture, a text prediction corresponding to the image based on the set of facial features, the set of hand features, and a set of defined terms associated with the multi-stage machine learning architecture; and initiating a prediction-based action based on the text prediction.

Example 18. The one or more non-transitory computer-readable media of example 17, wherein the parallel feature extraction model of the multi-stage machine learning architecture comprises a set of feature extraction models and generating the set of facial features comprises determining a set of image portions from the image; generating, using a first feature extraction model of the set of feature extraction models, a facial expression feature based on a first image portion of the set of image portions; generating, using a second feature extraction model of the set of feature extraction models, an eye movement feature based on a second image portion of the set of image portions; and generating, using a third feature extraction model of the set of feature extraction models, a lip position feature based on a third image portion of the set of image portions.

Example 19. The one or more non-transitory computer-readable media of example 18, wherein the facial expression feature, the eye movement feature, and the lip position feature are generated in parallel.

Example 20. The one or more non-transitory computer-readable media of any of examples 17 through 19, wherein initiating the prediction-based action based on the text prediction comprises generating, using a text-to-speech model, an audio signal based on the text prediction; and outputting, using a user interface, the audio signal.

Example 21. The computer-implemented method of example 1, wherein the method further comprises training the aggregation model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 10, wherein the one or more processors are further configured to train the aggregation model.

Example 25. The computing system of example 24, wherein the one or more processors are comprised in a first computing entity; and the aggregation model is trained by one or more other processors comprised in a second computing entity.

Example 26. The one or more non-transitory computer-readable storage media of example 17, wherein the instructions further cause the one or more processors to train the aggregation model.

Example 27. The one or more non-transitory computer-readable storage media of example 26, wherein the one or more processors are comprised in a first computing entity; and the aggregation model is trained by one or more other processors comprised in a second computing entity.

1. A computer-implemented method comprising:
receiving, by one or more processors, an image that depicts a facial expression and a hand position of a user;
generating, by the one or more processors and using a parallel feature extraction model of a multi-stage machine learning architecture, a set of facial features and a set of hand features from the image;
generating, by the one or more processors and using an aggregation model of the multi-stage machine learning architecture, a text prediction corresponding to the image based on the set of facial features, the set of hand features, and a set of defined terms associated with the multi-stage machine learning architecture; and
initiating, by the one or more processors, a prediction-based action based on the text prediction.

2. The computer-implemented method of claim 1, wherein the parallel feature extraction model of the multi-stage machine learning architecture comprises a set of feature extraction models and generating the set of facial features comprises:
determining a set of image portions from the image;
generating, using a first feature extraction model of the set of feature extraction models, a facial expression feature based on a first image portion of the set of image portions;
generating, using a second feature extraction model of the set of feature extraction models, an eye movement feature based on a second image portion of the set of image portions; and
generating, using a third feature extraction model of the set of feature extraction models, a lip position feature based on a third image portion of the set of image portions.

3. The computer-implemented method of claim 2, wherein the facial expression feature, the eye movement feature, and the lip position feature are generated in parallel.

4. The computer-implemented method of claim 1, wherein the image is one of a set of images in a video stream, the set of facial features and the set of hand features are based on a previous image associated with a previous time relative to the image, at least one of (i) the set of facial features comprises (a) a facial expression feature that identifies a sentiment classification for the user, (b) an eye movement feature that identifies a focus classification for the user, or (c) a lip position feature that identifies a lip movement classification based on a lip position change from the previous image to the image, or (ii) the set of hand features comprises a gesture recognition classification based on at least one of a hand or finger position change from the previous image to the image.

5. The computer-implemented method of claim 4, wherein at least one of the sentiment classification is based on a change of the facial expression from a previous facial expression of the previous image, or the eye movement feature is based on a change in eye focus from the previous facial expression to the facial expression.

6. The computer-implemented method of claim 1, wherein initiating the prediction-based action based on the text prediction comprises:
generating, using a text-to-speech model, an audio signal based on the text prediction; and
outputting, using a user interface, the audio signal.

7. The computer-implemented method of claim 6, wherein: the user interface comprises one or more audio devices of a user device and the image is recorded by one or more imaging devices of the user device, or the user interface comprises one or more audio devices of a second device and the image is recorded by the one or more imaging devices of the user device.

8. The computer-implemented method of claim 7, wherein the text prediction comprises text and a sentiment prediction and the text-to-speech model determines the audio signal from a set of defined audio signals based on the text and the sentiment prediction.

9. The computer-implemented method of claim 8, wherein the set of defined audio signals comprises a defined audio signal that corresponds to a text-sentiment pair associated with a corresponding textual prediction and a corresponding sentiment prediction.

10. A system comprising:
one or more processors; and
one or more memories storing processor-executable instructions that, when executed by the one or more processors, cause the one or more processors to perform operations comprising:
receiving an image that depicts a facial expression and a hand position of a user;
generating, using a parallel feature extraction model of a multi-stage machine learning architecture, a set of facial features and a set of hand features from the image;
generating, using an aggregation model of the multi-stage machine learning architecture, a text prediction corresponding to the image based on the set of facial features, the set of hand features, and a set of defined terms associated with the multi-stage machine learning architecture; and
initiating a prediction-based action based on the text prediction.

11. The system of claim 10, wherein the parallel feature extraction model of the multi-stage
machine learning architecture comprises a set of feature extraction models and generating the set of facial features comprises:
determining a set of image portions from the image;
generating, using a first feature extraction model of the set of feature extraction models, a facial expression feature based on a first image portion of the set of image portions;
generating, using a second feature extraction model of the set of feature extraction models, an eye movement feature based on a second image portion of the set of image portions; and
generating, using a third feature extraction model of the set of feature extraction models, a lip position feature based on a third image portion of the set of image portions.

12. The system of claim 11, wherein the facial expression feature, the eye movement feature, and the lip position feature are generated in parallel.

13. The system of claim 10, wherein the image is one of a set of images in a video stream, the set of facial features and the set of hand features are based on a previous image associated with a previous time relative to the image, at least one of (i) the set of facial features comprises (a) a facial expression feature that identifies a sentiment classification for the user, (b) an eye movement feature that identifies a focus classification for the user, or (c) a lip position feature that identifies a lip movement classification based on a lip position change from the previous image to the image, or (ii) the set of hand features comprises a gesture recognition classification based on at least one of a hand or finger position change from the previous image to the image.

14. The system of claim 13, wherein at least one of the sentiment classification is based on a change of the facial expression from a previous facial expression of the previous image, or the eye movement feature is based on a change in eye focus from the previous facial expression to the facial expression.

15. The system of claim 10, wherein initiating the prediction-based action based on the text prediction comprises:
generating, using a text-to-speech model, an audio signal based on the text prediction; and
outputting, using a user interface, the audio signal.

16. The system of claim 15, wherein the text prediction comprises text and a sentiment prediction and the text-to-speech model determines an audio signal from a set of defined audio signals based on the text and the sentiment prediction.

17. One or more non-transitory computer-readable media storing processor-executable instructions that, when executed by one or more processors, cause the one or more processors to perform operations comprising:
receiving an image that depicts a facial expression and a hand position of a user;
generating, using a parallel feature extraction model of a multi-stage machine learning architecture, a set of facial features and a set of hand features from the image;
generating, using an aggregation model of the multi-stage machine learning architecture, a text prediction corresponding to the image based on the set of facial features, the set of hand features, and a set of defined terms associated with the multi-stage machine learning architecture; and
initiating a prediction-based action based on the text prediction.

18. The one or more non-transitory computer-readable media of claim 17, wherein the parallel feature extraction model of the multi-stage machine learning architecture comprises a set of feature extraction models and generating the set of facial features comprises:
determining a set of image portions from the image;
generating, using a first feature extraction model of the set of feature extraction models, a facial expression feature based on a first image portion of the set of image portions;
generating, using a second feature extraction model of the set of feature extraction models, an eye movement feature based on a second image portion of the set of image portions; and
generating, using a third feature extraction model of the set of feature extraction models, a lip position feature based on a third image portion of the set of image portions.

19. The one or more non-transitory computer-readable media of claim 18, wherein the facial expression feature, the eye movement feature, and the lip position feature are generated in parallel.

20. The one or more non-transitory computer-readable media of claim 17, wherein initiating the prediction-based action based on the text prediction comprises:
generating, using a text-to-speech model, an audio signal based on the text prediction; and
outputting, using a user interface, the audio signal.
